(19) United States
(12) Patent Application Publication
(10) Pub. No.: US 2018/0178607 A1
(43) Pub. Date: Jun. 28, 2018

(54) JOINT CONNECTION AND ARRANGEMENT FOR MOUNTING A WHEEL

(71) Applicant: ZF Friedrichshafen AG, Friedrichshafen (DE)

(72) Inventor: Felix HAEUSLER, Redondo Beach, CA (US)

(21) Appl. No.: 15/736,135

(22) PCT Filed: May 17, 2016
(86) PCT No.: PCT/EP2016/060960

§ 371 Date: Dec. 13, 2017

(30) Foreign Application Priority Data
Jun. 15, 2015 (DE) 10 2015 210 917.8

(51) Int. Cl. B60G 7/00; B60G 3/20; B62D 17/00; B62D 7/14

(52) U.S. Cl. CPC B60G 7/006; B60G 7/005; B60G 3/20; B62D 17/00; B62D 7/146; B60G 2200/144; B60G 2206/1116; B60G 2204/143; B60G 2204/148; B60G 2204/4103; B60G 2204/416; B60G 2204/418; B60G 2204/4222; B60G 2200/462

(57) ABSTRACT

An articulated joint (1) for the articulated connection of a first chassis component (2) to a second chassis component (3), which includes a joint body (4) with a central axis (m) and a rotational axis (a). A housing (6) holds the joint body (4) such that the joint body (4) can be attached to the first chassis component (2) and the housing (6) can be attached to the second chassis component (3). The rotational axis (a) is positioned eccentrically relative to the central axis (m).

This application is a National Stage completion of PCT/EP2016/060960 filed May 17, 2016, which claims priority from German patent application serial no. 10 2015 210 917.8 filed Jun. 15, 2015.

### FIELD OF THE INVENTION

The invention concerns an articulated joint for the articulated connection of a first and a second component. The invention also concerns an arrangement for mounting a wheel on a motor vehicle.

### BACKGROUND OF THE INVENTION

Articulated joints are known in particular from chassis construction for motor vehicles: for example, control arms of a wheel suspension are connected to one another or to other chassis components by means of such joints. The ball joints used in practice are illustrated and described in the technical literature, for example in “Fahrwerkhandbuch” (Chassis Handbook) by Bernd Heißing et al., 4^{th} Edition, 2013, pp. 342-356. Basically a ball joint comprises a joint body called the ball pin, and a housing with an optional ball shell, which holds the ball pin. The ball joint has numerous rotational or swivel axes and correspondingly many degrees of freedom. Rotary joints (see p. 361 in Fahrwerkhandbuch, Bernd Heißing et al.) differ from ball joints, in that they have a cylindrical joint body with only one rotational axis (the cylinder axis) and consequently only one degree of rotational freedom. Besides ball joints and rotary joints, in chassis rubber mountings are also used for the connection of chassis components (see Fahrwerkhandbuch, Bernd Heißing et al., pp. 356-361). Rubber mountings have many degrees of freedom, but the movement of the components connected by the rubber mounting entails some force and the guiding is not as exact as it is with ball joints. In summary, it can be said that although ball joints allow numerous different rotational and swivel movements and rubber mountings allow rotational, swivel and translation movements, in the latter case thrust or shear forces of the elastomer have to be overcome. For practical requirements in chassis construction there is the potential for the further development of articulated joints.

### SUMMARY OF THE INVENTION

According to a first aspect of the invention, in an articulated joint for the articulated connection of chassis components of the type mentioned, it is provided that the rotational axis of the joint body is arranged eccentrically relative to its central or symmetry axis. The rotational axis, which can be in the form of a rotary joint, is parallel with but offset relative to the central axis. When the joint body rotates about its rotational axis, this gives an additional degree of freedom in the form of a translation movement. Such an extension of the degrees of freedom in an articulated joint meets various requirements relating to the wheel suspension in chassis construction. By virtue of the additional translational degree of freedom obtained, the articulated joint is also simplified since there is no need for a second articulated joint.

According to a preferred embodiment, at least one fixing means is provided a distance away from the rotational axis, which serves for the introduction and absorption of adjustment or bearing forces. In the case when an adjustment force is applied, for example by an actuator, a torque is produced about the rotational axis which results in pivoting of the joint body about the eccentric rotational axis and hence to translation movement of the joint body. The arrangement and design of the fixing means depends on the purpose intended in each case.

In a further preferred embodiment, the joint body is in the form of a ball pin, i.e. the articulated joint consists of a ball joint with numerous rotational degrees of freedom. The chassis components connected to one another by means of the articulated joint can thus be pivoted relative to one another about a plurality of spatially arranged rotational axes.

In a further preferred embodiment, the joint body is in the form of a cylindrical body or pin, i.e. a rotary or pivot joint with only one rotational axis and therefore only one rotary degree of freedom. In this case too there is advantageously an additional, translational degree of freedom.

According to another preferred embodiment, the at least one fixing means is in the form of a pin or bolt, and preferably, two bolts arranged on a common longitudinal axis are inserted into corresponding bores in the joint body. An actuator can be articulated to these bolts, so that its adjusting force can be transmitted to the joint body to produce a torque.

In a further preferred embodiment, a bearing sleeve arranged coaxially with the rotational axis is fitted and can rotate in the joint body. Thus, the bearing sleeve forms a pivot joint arranged eccentrically in the joint body, which makes it possible for the joint body to pivot about the rotational axis.

According to another preferred embodiment, slide bearings or roller bearings are provided between the bearing sleeve and the joint body. This reduces the friction between the bearing sleeve and the joint body during rotational movement. Accordingly, only small adjustment forces are needed for adjustment purposes.

In another preferred embodiment, the bearing sleeve is braced against the first component by a tension bolt that passes through the bearing sleeve. Thus, the bearing sleeve acts as an axis which is fixed relative to the first component and allows rotation of the joint body.

According to a further preferred embodiment, the first component is in the form of a subframe of a wheel suspension, particularly preferably a motor vehicle rear axle. A subframe can for example be understood to mean an axle support or subframe, i.e. an intermediate component between the individual wheel suspension and the chassis or the vehicle body. Thus, the subframe serves as a fixed point for the wheel suspension.

In a further preferred embodiment, the second component is a control arm, for example a transverse control arm or track-rod of a wheel suspension of a motor vehicle. Thus, the articulated joint according to the invention with its eccentrically built-in rotary joint can serve as an articulated connection between the subframe and the wheel suspension.

In another preferred embodiment, an actuator can be articulated to the joint body by way of the at least one fixing means. The adjusting force of the actuator brings about a rotational movement and hence translational movement of the joint body. This can be advantageous, for example for track adjustment or control arm movement in rear axle steering.

According to a further aspect of the invention, the track-rod of a wheel suspension is connected by the articulated joint according to the invention on one side to the subframe and on the other side to an actuator, wherein the fixing to the subframe is made by the rotary joint in the joint body. The adjustment forces of the actuator are for example introduced via bolts in the joint body, whereby a change of the track angle of the rear wheels can be produced by way of the track-rod.

According to another aspect of the invention, in a wheel suspension arrangement it is provided that one of two articulated joints on the wheel side on a four-point link is made as an articulated joint according to the invention, i.e. with an axially offset rotary joint. The advantage of this arrangement is that a conventional integral control arm of an integral axle can be replaced by the articulated joint according to the invention. Integral control arms are known in four-point or trapezoidal suspensions (see “Fahrwerkhandbuch” by Bernd Heißing, 4^{th} Edition, pp. 451-452); they form a short additional control arm (intermediate coupling) between the lower and upper transverse arms and serve to absorb braking or acceleration torques. This function can be taken up by the articulated joint according to the invention in place of the integral control arm, and this indeed because of the additional translational degree of freedom. The result is a simpler wheel suspension.

### BRIEF DESCRIPTION OF THE DRAWINGS

Example embodiments of the invention are illustrated in the drawings and will be described in greater detail below, so that other features and/or advantages may emerge from the description and/or from the drawings, which show:

FIG. 1: An articulated joint according to the invention, with an eccentric rotational axis,

FIG. 2a: The articulated joint according to FIG. 1, seen in cross-section in an initial position,

FIG. 2b: The articulated joint in a displaced position,

FIG. 3: The articulated joint according to the invention, built into a track-rod of a wheel suspension,

FIG. 4a: An articulated joint according to the invention for connecting a four-point link to a wheel carrier of a wheel suspension,

FIG. 4b: The wheel suspension according to FIG. 4a, looking in the direction toward the inside of the wheel carrier.

### DETAILED DESCRIPTION OF THE PREFERRED EMBODIMENTS

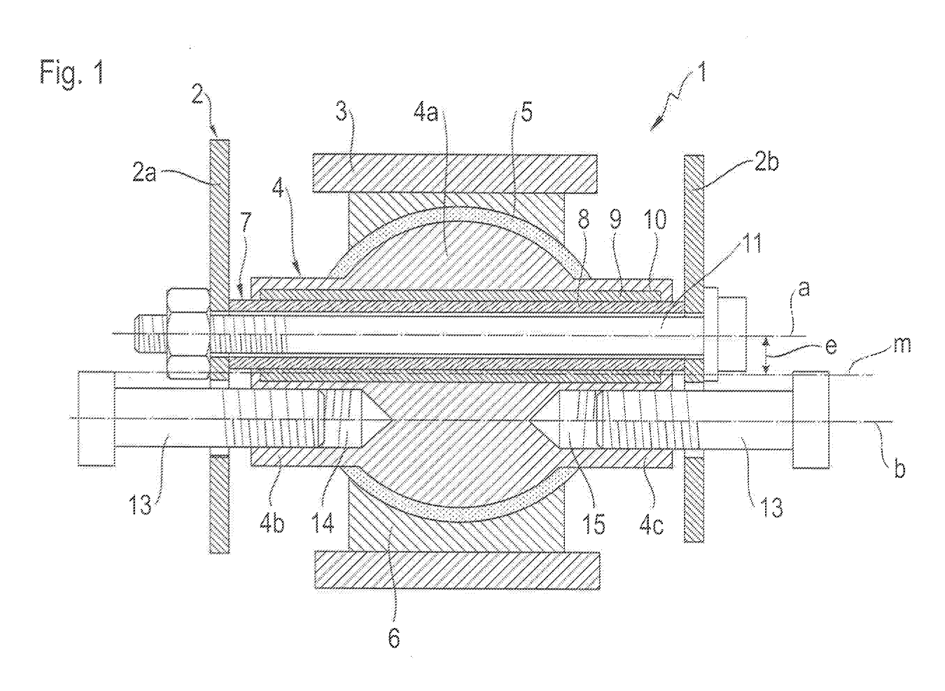

FIG. 1 shows an articulated joint 1 according to the invention between a first component 2 in the form of a subframe 2a, 2b of a motor vehicle and a second component 3 in the form of a control arm 3 of a wheel suspension for a motor vehicle. The subframe 2 can be understood to be an axle support fixed to the vehicle, to which control arms of a wheel suspension are articulated. The articulated joint 1 comprises a joint body 4 in the form of a ball pin with an axis of symmetry or central axis m. The joint body 4 has a ball-shaped part 4a and two cylindrical pins 4b, 4c connected to the ball-shaped part 4a. The ball-shaped part 4a is held and able to rotate in a shell-shaped housing 6 which has a slide-bearing lining 5 and is connected to the control arm 3. Thus, together with the housing 6 the joint body 4 or ball pin forms a ball joint with rotational degrees of freedom about three spatial axes. Parallel to the central axis m and offset by the amount of an eccentricity e there is arranged a rotational axis a of a rotary joint 7. The rotary joint 7 comprises a bearing sleeve 8 and a slide bearing 9, which is held in a bore 10 of the joint body 4 arranged coaxially with the rotational axis a. Through the bearing sleeve 8 passes a tension bolt 11, which clamps the bearing sleeve 8 at its ends between the subframe 2a, 2b and thereby fixes it in a form-enclosed manner. In addition the joint body 4 has two fixing means in the form of bolts 12, 13 arranged on a common longitudinal axis, which are pressed into corresponding blind-hole bores 14, 15 in the pins 4b, 4c of the joint body 4. The bolts 12, 13 serve as linkage points for an actuator (not shown).

Otherwise than in the representation shown in FIG. 1 the joint body 4, in particular its ball-shaped part 4a, can also be made as a cylindrical body with the central axis m as the cylinder axis. Thus, instead of the ball joint a rotary joint with the rotational axis m could also work.

Also otherwise than in the representation of FIG. 1, the component 2 can be a control arm and the component 3 a subframe. An actuator (not shown) could then be linked directly to the component 2; the bores 14, 15 and the fixing means 12, 13 could be omitted or replaced by appropriate fixing means modifications on the control arm.

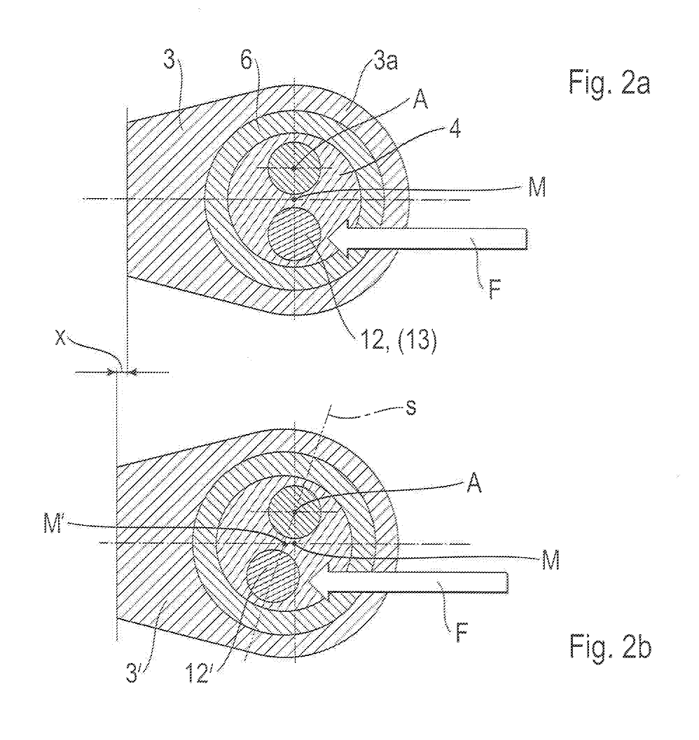

FIGS. 2a and 2b show the articulated joint according to FIG. 1, seen in cross-section in different positions. The pass-through point of the rotational axis a (FIG. 1) through the plane of the drawing is denoted A in FIGS. 2a and 2b and is a fixed point, since the rotary joint 7 (FIG. 1) is fixed relative to the subframe 2a, 2b. The pass-through point of the central axis m (FIG. 1) through the plane of the drawing is denoted M. The housing 6, in which the ball-shaped part 4a of the joint body 4 is held, is surrounded by a ring-shaped eye 3a of the control arm 3. In the area of the bolts 12, 13 an adjustment force F of an actuator (not shown) is applied and—as shown in FIG. 2b—this causes the joint body 4 to pivot about the fixed point A or the positionally fixed rotational axis a (FIG. 1). The pivoting can be recognized by a broken indicator line s passing through the fixed point A and by the displaced position of the bolt 12′. Due to the pivoting there is translation movement of the central point M from its initial position in FIG. 2a, toward the central point M′ in FIG. 2b. At the same time as the displacement of the central point M the control arm 3 is displaced to position 3′, as is shown clearly by the displacement path x. Thus, besides the rotational degrees of freedom, by virtue of the ball joint 4a the articulated joint according to the invention has in addition a translational degree of freedom which is made possible by the eccentrically arranged rotary joint 7. In contrast to the rubber mountings mentioned earlier, the rotary joint 7 gives rise to only minimal bearing friction, so that the adjustment force F required for the displacement movement x is relatively small.

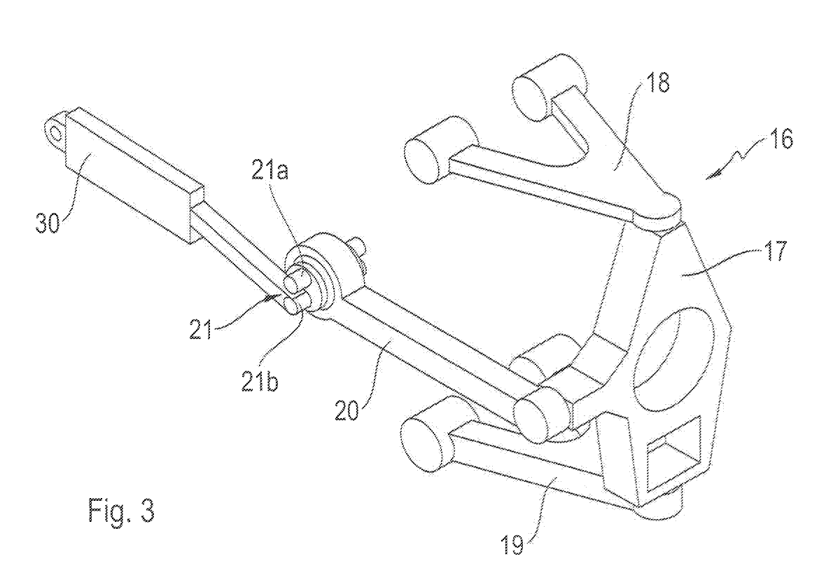

FIG. 3 shows an example application of the invention for a wheel suspension 16 of a rear axle steering system of a motor vehicle. The wheel suspension 16 comprises a wheel carrier 17 articulated to an upper transverse control arm in the form of a wishbone 18 and a lower transverse control arm 19 also in the form of a wishbone. Not shown in the figure is that the two transverse control arms 18, 19 are connected on the vehicle side to a subframe. Attached to the wheel carrier 17 is a track-rod 20, which is connected on the vehicle side, i.e. to the subframe (not shown), by means of the articulated joint 21 according to the invention. The articulated joint 21, which is connected to the vehicle-side end of the track-rod 20, comprises an eccentric rotary joint 21a and a pin 21b for the articulation of an actuator 30. The rotary joint 21a is connected in a fixed position to the subframe (not shown). When the actuator is actuated the bolt 21b pivots about the rotary joint 21a so that the track-rod 20 undergoes a translation movement which is transmitted to the wheel carrier 17, causing it to rotate about its vertical axis, i.e. changing the track angle.

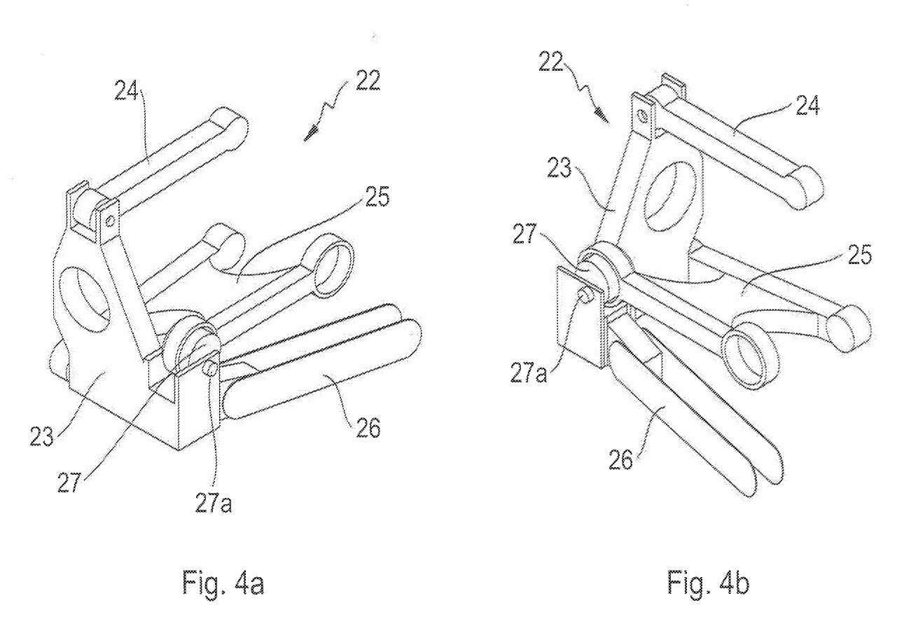

FIGS. 4a and 4b show a further example application of the invention for a wheel suspension 22, which is shown in different isometric views. A wheel carrier 23 is connected to a subframe (not shown) by an upper transverse control arm 24 and a lower transverse control arm in the form of a four-point or trapezoidal link 25. Furthermore, the wheel carrier 23 is attached to a track-rod 26. The four-point link 25 is connected by two joints to the wheel carrier 23, one of these two joints being an articulated joint 27 according to the invention. In this case the eccentrically arranged rotary joint 27a is connected to the wheel carrier 23. By virtue of the articulated joint 27 the four-point link 25, in addition to the three rotational degrees of freedom, can also undergo translation movement in the area of the articulated joint 27. The wheel suspension 22 according to the invention corresponds to the trapezoidal link suspension known from the prior art mentioned at the beginning, in which the upper and lower transverse control arms are connected to one another by an additional link also known as the integral link. This known integral link, in the form of an intermediate coupling, is replaced by the articulated joint 27 according to the invention, whereby its function is preserved but the wheel suspension as a whole is simplified.

### INDEXES

1 Articulated joint
2 First chassis component
2a Subframe
2b Subframe
3 Second chassis component/control arm
3′ Control arm, displaced
4 Joint body
4a Ball-shaped part
4b Pin
4c Pin
5 Slide-bearing lining
6 Housing
7 Rotary joint
8 Bearing sleeve
9 Slide bearing
10 Bearing bore
11 Tension bolt
12 Bolt
12′ Bolt, displaced
13 Bolt
14 Blind-hole bore
15 Blind-hole bore
16 Wheel suspension
17 Wheel carrier
18 Upper transverse control arm
19 Lower transverse control arm
20 Track-rod
21 Articulated joint
21a Rotary joint
21b Bolt
22 Wheel suspension
23 Wheel carrier
24 Upper transverse control arm
25 Lower transverse control arm
26 Track-rod
27 Articulated joint
27a Rotary joint
30 Actuator
A Pivot point
a Rotational axis
b Longitudinal axis
M Central point
M′ Central point, displaced
m Central axis
e Eccentricity
F Adjustment force/Actuator
s Indicator line
x Displacement path

1-14. (canceled)

15. An articulated joint for an articulated connection of a first chassis component (2) to a second chassis component (3), the articulated joint comprising:
a joint body (4) having a central axis (m) and a rotational axis (a),
a housing (6) holding the joint body (4),
the joint body (4) being attachable to the first chassis component (2),
the housing (6) being attachable to the second chassis component (3), and
the rotational axis (a) being arranged eccentrically relative to the central axis (m).

16. The articulated joint according to claim 15, wherein the joint body (4) comprises at least one fixing mechanism (12, 13) arranged a distance away from the rotational axis (a) for absorbing either adjustment forces or bearing forces (F).

17. The articulated joint according to claim 15, wherein the joint body is in a form of a ball pin (4, 4a).

18. The articulated joint according to claim 15, wherein the joint body (4) is cylindrical.

19. The articulated joint according to claim 16, wherein the at least one fixing mechanism is in a form of a pin or a bolt (12, 13).

20. The articulated joint according to claim 15, wherein a bearing sleeve (8) is fitted in the joint body (4) coaxially with the rotational axis (a), and the bearing sleeve (8) is able to rotate in the joint body.

21. The articulated joint according to claim 20, wherein either a slide bearing or a roller bearing is arranged between the bearing sleeve (8) and the joint body (4).

22. The articulated joint according to claim 21, wherein the bearing sleeve (8) is braced against the first chassis component (2, 2a, 2b) by a tension bolt (11) that extends through the bearing sleeve (8).

23. The articulated joint according to claim 15, wherein the first chassis component is in a form of a subframe (2a, 2b) of a wheel suspension of a motor vehicle.

24. The articulated joint according to claim 15, wherein the second chassis component is in a form of a control arm (3) of a wheel suspension of a motor vehicle.

25. The articulated joint according to claim 16, wherein an actuator is articulated to either the at least one fixing mechanism or a bolt (12, 13).

26. An arrangement (16) for the suspension of a wheel on a motor vehicle, the arrangement comprising:
a wheel carrier (17),
an upper transverse control arm (18),
a lower transverse control arm (19),
a track-rod (20),
a subframe (2),
each of the upper and lower transverse control arms (18, 19) being connected, on a first side, to the wheel carrier (17) and, on a second side, to the subframe (2),
the track-rod (20) being connected both to the subframe (2) and also to an actuator (F) by way of an articulated joint (1; 21, 21a, 21b),
the articulated joint comprising a joint body (4) with a central axis (m) and a rotational axis (a),
a housing (6) holding the joint body (4),
the joint body (4) being attachable to the subframe (2),
the housing (6) being attachable to the track-rod, and
the rotational axis (a) being arranged eccentrically relative to the central axis (m).

27. The arrangement according to claim 26, wherein the housing (6) is held in the track-rod (20), the joint body (4) is connected to the subframe (2) by a bearing sleeve (8; 21a), and a fixing mechanism or a bolt (12, 13; 21b) is connected to the actuator.

28. An arrangement (22) for the suspension of a wheel on a motor vehicle, the arrangement comprising:
a wheel carrier (23),
an upper transverse control arm (24),
a lower transverse control arm (25),
a track-rod (26),
a subframe (2),
each of the upper and the lower transverse control arms (24, 25) being connected, on a first side, to the wheel carrier (23) and, on a second side, to the subframe (2),
the lower transverse control arm being in a form of a four-point or trapezoidal link (25) and having two articulated joints on a wheel side,
a first of the two articulated joints (27) is made for an articulated connection of the subframe (2) to a second chassis component (3),
the articulated joint comprising a joint body (4) with a central axis (m) and a rotational axis (a),
a housing (6) holding the joint body (4),
the joint body (4) being attachable to the subframe (2),
the housing (6) being attachable to the second chassis component (3), and
the rotational axis (a) being arranged eccentrically relative to the central axis (m).
